(19) United States
(12) Patent Application Publication
(10) Pub. No.: US 2009/0277331 A1
(43) Pub. Date: Nov. 12, 2009

(54) HYDROGEN SEPARATION COMPOSITE MEMBRANE MODULE AND THE METHOD OF PRODUCTION THEREOF

(75) Inventors: Anwu LI, Richmond (CA); John Ross GRACE, Vancouver (CA); Choon Jim LIM, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: MEMBRANE REACTOR TECHNOLOGIES LTD., Vancouver (CA)

(21) Appl. No.: 12/437,763

(22) Filed: May 8, 2009

Related U.S. Application Data
(60) Provisional application No. 61/051,872, filed on May 9, 2008.

(51) Int. Cl. B01D 53/22; B05D 3/00; B01D 67/00

(52) U.S. Cl. 96/11; 427/245; 204/192.12

(57) ABSTRACT

This invention relates to a metallic composite membrane for separating hydrogen from a mixed gas, a membrane module and a manufacturing method thereof. The composite membrane consists of a three-layer sandwich structure, e.g. the porous metal substrate, an intermediate layer and the hydrogen-selective dense thin metal layer. In the embodiments of the invention, the porous metal substrates were first pretreated to reduce their surface roughness without reducing their gas permeability. The pretreated substrates were coated with intermediate layer, wherein the intermediate layer served as not only a barrier layer to prevent interdiffusion between the substrate and the hydrogen-selective layer, but also a surface modifier to reduce surface roughness and pore size of the substrate. A hydrogen-selective metal layer was then deposited on the intermediate layer-coated substrate by coating methods. Since the substrate with the intermediate layer has a smoother surface with a smaller pore size, a thinner hydrogen-selective metal membrane can be used to form a dense pinhole-free membrane. This not only reduces the metal loading of the composite membrane, but also increases its hydrogen permeance and selectivity of the composite membrane. The module design according to the invention provides solutions to the problems that result from high welding temperatures or high mechanical compressing force caused by the joining of a composite membrane with other parts through Swagelok, welding, brazing and gasket etc.

### REFERENCE TO RELATED APPLICATION

This application claims Convention priority on U.S. provisional application Ser. No. 61/051,872, filed May 9, 2008.

### FIELD OF THE INVENTION

This invention relates to a metallic composite membrane for separating hydrogen from a mixed gas, a membrane module and a manufacturing method thereof. More particularly, it relates to a hydrogen permeation membrane module having high hydrogen permeability, good mechanical and thermal stability, and appropriate hydrogen selectivity, as well as a manufacturing method including the methods of modifying the porous substrate and depositing the hydrogen-selective metallic top layer.

### BACKGROUND OF THE INVENTION

For the world to move toward the hydrogen economy, one of the critical factors is the availability of inexpensive, reliable and pure hydrogen, produced in such a manner that greenhouse gases emissions are minimized. Currently, hydrogen is mainly produced via steam methane reforming, followed by conventional separation techniques, such as high and low shift reactions followed by pressure swing adsorption. Membrane separation using hydrogen selective membranes is an alternative method for obtaining cheap and pure hydrogen since it involves an efficient and energy-effective one-step separation process. Two of the most common gas separation membranes are polymer membranes and metallic composite membranes. Due to their poor thermal stability, polymer membranes are only viable for the applications of separating hydrogen at low temperatures. Metallic membranes are usually employed for the applications of separating hydrogen at high temperatures. Typical metallic membranes include Pd, Pt, Nb, Ta etc and their alloys. The Pd-based membranes are the most common membranes for hydrogen separation due to their high resistance to hydrogen embrittlement and oxidation, good thermal stability and favourable catalytic activity for hydrogen dissociation and recombination, as well as appropriate hydrogen permeability.

Since Pd is expensive and its hydrogen permeability is generally inversely proportional to its thickness, Pd-based membranes are usually prepared in composite form consisting of a thin Pd-based layer, to provide high hydrogen permselectivity, on a porous substrate with adequate mechanical strength to support the thin Pd-based layer. In U.S. Pat. No. 5,652,020, issued to Collins et al., an embodiment was disclosed to produce thin palladium composite membrane on porous ceramic tubular substrate by electroless plating. However, the fragility of the ceramic makes it difficult to connect the resultant composite membranes to metallic vessels or reactors, thereby limiting their applications on a large scale.

Porous stainless steel was employed as the substrate for thin Pd-based membrane by J. Shu et al in CATALYSIS TODAY 25 (1995) 327-332. This kind of metallic substrate possesses many advantages, such as a similar thermal expansion coefficient to the Pd-based films, ease of modularization and processing, good weldability with regular stainless steel parts, ductility and low cost. However, they observed that hydrogen permeability of the composite membrane decreased with time at high temperature and found that the interdiffusion between Pd-based membrane and the stainless steel substrate was the cause of the decrease in permeability. Interdiffusion is more evident at higher temperatures. In an embodiment, disclosed by J. Shu et al in THIN SOLID FILMS 286 (1996) 72-79, an interdiffusion barrier layer of TiN was introduced between the Pd-based layer and the porous stainless steel substrate by sputtering to prevent the interdiffusion. In another embodiment, disclosed by Y. H. Ma in U.S. Pat. No. 6,152,987, the metallic substrate was oxidized under a controlled conditions and a layer of oxides was hence formed on the surface of the substrate. A layer of hydrogen-selective metal membrane was subsequently coated onto the oxidized surface. The oxide layer then served as the barrier layer to prevent the interdiffusion between the metallic substrate and the selective layer.

The hydrogen-selective metallic layer deposited on the barrier-layer-coated substrate is generally achieved by various coating methods, such as sputtering, PVD, CVD, electroplating or electroless plating. In addition to the coating method, the properties of the porous substrate to be coated, such as its surface roughness, pore size etc, remarkably affect the morphology, micro-structure and the integrity of the coated metallic layer and subsequently affect the performance of the composite membrane, e.g. its selectivity and stability. Mardilovich et al in the DESALINATION 144 (2002) 85-89 found that the minimum thickness of Pd required to achieve a pinhole-free layer by electroless plating is approximately three times the diameter of the largest pores in the substrate. The porous ceramic substrate can be relatively easily and inexpensively manufactured in an asymmetric structure consisting of multiple porous layers having large porosity and decreasing pore size toward its surface. The pore size and the roughness of the surface layer could be a few nanometers or even smaller. Hence, it is relatively easy to deposit a thin defect-free metallic membrane layer on this kind of substrate. Unlike the ceramic substrate, it is much more expensive and difficult to manufacture the porous metallic substrate in such asymmetric structure. Even for the best commercially available porous stainless steel substrate, both its surface roughness and largest pore size are too big, typically in the range 10-20 m. Therefore, it is difficult to deposit a thin (<10 m) pinhole-free Pd-based layer on this substrate without proper pre-treatment. Nam et al reported a method, to reduce the surface roughness and the pore size of the porous stainless steel substrate, disclosed in the JOURNAL OF MEMBRANE SCIENCE 153 (1999) 163-173. They dispersed sub-micro Ni particles on the surface of porous stainless steel substrate and then calcined it at 1073K for 5 h, followed by vacuum electrodeposition of copper. A pinhole-free Pd—Ni alloy layer of thickness<10 m was successfully obtained on this pre-treated substrate, even though this composite membrane may suffer from permeance deterioration at elevated temperature due to the interdiffusion as result of direct contact of the Pd—Ni alloy layer with a metallic substrate.

Therefore, in order to deposit a thin pinhole-free metallic layer on a porous metallic substrate and to achieve good mechanical and thermal stability of the resultant composite membrane, the porous metallic substrate must be pre-coated with an interdiffusion barrier layer, and its surface roughness as well as its surface pore size, must be reduced.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

A hydrogen permeation composite membrane according to this invention consists of three-layer structure, a porous substrate, an intermediate layer and a thin hydrogen-selective layer. The substrate is a porous metal with appropriate gas permeability and mechanical strength and can be of tubular or planar shape. The possible substrate candidates include porous stainless steel or other alloys containing Fe, Cr, Ni, Mo and V etc and having good weldability with typical industrial metallic parts. The intermediate layer is bonded to the target surface of the porous metallic substrate. The intermediate layer is a porous layer and can be a ceramic or oxide layer, such as alumina, silica or titania. The thin hydrogen-selective layer overlies the other surface of the intermediate layer. The thin hydrogen-selective layer is a dense metal membrane that is permeable only to hydrogen and can be made of pure precious metals (Pd, Pt and Au) and their alloys with Ag, Cu, Y, Ru or Ce etc.

A method for manufacturing a hydrogen separation membrane module of this invention includes fabricating a thin dense metal composite membrane having appropriate hydrogen permeability, selectivity and stability even at high temperatures and designing a membrane module having good weldability with regular metallic industrial parts. The technique for fabricating the composite membrane includes selecting a porous metal substrate, pretreating the metal substrate, coating the pretreated substrate with a porous intermediate layer, and depositing a thin dense metal layer on the coated substrate. The porous metal substrate is commercially available and suitable for the target applications. It must possess a proper thickness, porosity, pore size and appropriate stability. Its weldability with regular metal parts needs to be taken into account as well. The selected substrate also undergoes a pretreatment step to reduce its surface roughness. The pretreated substrate is further coated with a porous ceramic layer, preferably by the sol-gel technique. This intermediate layer serves as the interdiffusion barrier to enhance the stability of the composite membrane at high temperatures. More critical, according to this invention, this intermediate layer also serves as the surface modifier of the pretreated porous metal substrate, reducing its surface roughness and pore size. Preferably, this intermediate layer is 0.5-10 m thick and has smaller pores and higher porosity than the substrate so that it does not increase the gas permeation resistance of the substrate significantly. The hydrogen-selective metal layer is then deposited on the surface of the intermediate layer by various coating techniques, such as electroless plating, electroplating, CVD, or sputtering Since the substrate with the intermediate layer has a smoother surface and smaller pore size, thinner hydrogen-selective metal membrane can be used to form a dense pinhole-free membrane. This not only reduces the metal loading of the composite membrane, but also increases its hydrogen permeance. Therefore, this is one of the critical features of the invention.

The membrane module design is important for scaling-up the composite membrane and facilitates its applications under practical conditions, especially at high temperature and hydrogen pressure. The composite membrane must join with other parts to form a module through Swagelok, welding, brazing and gasket etc. It is required that the joining should cause no damage to the thin metal membrane layer as result of high welding temperatures or high mechanical compressing or handling forces. The module design according to the invention provides solutions to the problems associated with the joining of the composite membrane. For planar porous metal substrate, a solid frame is welded to its perimeter. For tubular substrate, two solid metal tubes are welded to both of its ends.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a top view of the surface of the stainless steel substrate at various stages under SEM, 1a) the original stainless steel substrate; 1b) the surface after polishing and etching; 1c) the surface of the substrate coated using the sol containing larger particles; and 1d) the surface of the substrate coated using the sol containing smaller particles.

FIG. 2a is a cross-section view of the disc composite membrane module.

FIG. 2b is an enlarged cross-section view of the portion of the disc composite membrane module shown in dotted outline in FIG. 2a.

### DETAILED DESCRIPTION OF THE INVENTION

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawing should be regarded in an illustrative, rather than in a restrictive, sense.

Porous metal and porous ceramic substrates are most commonly used for thin metallic composite membranes. Porous metal possesses many advantages over porous ceramic, such as similar thermal expansion coefficient to the hydrogen-selective metallic membrane, ease of modularization and processing, good ductility and weldability when joining with regular metal parts in practical applications. However, porous metal substrates usually suffer from two major problems. One is the problem of interdiffusion. If the hydrogen-selective metal layer is immediately deposited on the surface of the porous metal substrate, inter-metal diffusion between membrane and the substrate occurs at elevated temperatures, forming an intermediate layer of low permeability and reducing hydrogen permeability of the composite membrane with time. The further problem is associated with the structure features of the metal substrate. Commercially available porous substrates generally have large pores, a wide pore size distribution and rough surface. Consequently, it is difficult to deposit a thin pinhole-free metal membrane on such substrates with large pore size and coarse roughness in surface. Even if the thin pinhole-free metal membrane is coincidently deposited, it is unstable under pressure and temperature. Therefore, it is of great importance to modify the metal substrate before depositing the thin metal membrane. In this invention, a novel and effective method is disclosed to simultaneously solve both of these problems. A method for fabricating the composite membranes on the modified substrate and a design of membrane module are disclosed as well.

The invention is directed to providing a method for manufacturing a metallic composite membrane on the porous metallic substrate with appropriate hydrogen permeability, selectivity and stability.

The invention also provides a technique for pre-treating the porous metallic substrate, including a method to modify its surface roughness and its pore size and a method to coat an interdiffusion barrier layer on the substrate.

The invention further provides a method to deposit a thin pinhole-free hydrogen-selective metallic layer on the pre-treated substrate.

The invention also provides a new design of membrane module in accordance with the aforementioned composite membrane so that the module can be readily scaled up and joined to regular industrial metallic vessels, reactors, tubes or other parts.

According to this invention, the porous metal substrate must undergo steps of pretreatment and modification before it becomes a suitable substrate for supporting thin metal membrane. The major steps are described below.

### Polishing

The surface of the commercially available porous metal substrate is usually rough and needs to be polished before use. The substrate surface to be deposited is polished using sandpapers with increasing grits step by step and the other surface of the substrate is not polished. After polishing, the surface roughness of the substrate decreases from 10˜25 m originally to about 1-5 m, preferably 1-2 m.

### Etching

The polishing reduces the surface roughness of the substrate. However, as a result of polishing, some metal originally on protuberances is displaced to the low pits and pore mouths of the substrate, blocking most pore entrances on the surface and causing the disc to be hardly permeable to gas. The polished surface is next etched using a mixed acid of nitric acid and hydrochloric acid to open up its pores. The composition and volume of the mixed acids depend on the type of the substrate. The other surface is protected to avoid etching by the acid. After completing the etching, the disc is immediately washed with clean water to remove all acid solution remaining in pores, preventing continuation of etching which could damage the framework of the substrate, reducing its mechanical strength. The substrate is then dried in the oven at 120° C.

### Ceramic Layer Coating

The polished surface of the substrate is then coated with ceramic layers, serving as the surface modifier and the interdiffusion barrier layer. The ceramic layer is obtained by various methods, preferably the sol-gel technique. The polished surface is first coated with sols containing bigger -alumina particles of mean diameter 1-8 m, preferably 2-4 m. The surface is then coated with a sol containing smaller -alumina particles of mean diameter 0.1-1 m, preferably 0.2-0.4 m. The coated substrate is subject to calcination in a reducing or inert environment at about 600° C. After coating, the surface roughness of the substrate is significantly reduced.

### Depositing Thin Hydrogen-Selective Metallic Layer

A thin hydrogen-selective metallic layer is then deposited on the ceramic-coated surface of the substrate by one of several coating methods, such as sputtering, electroplating or electroless plating. The electroless plating technique is preferred because of its many advantages, including uniformity of deposition on complex shapes, hardness, low cost, simple equipment and ease of scale-up. The metallic layer can be pure Pd, Pt, Au, etc. and their alloys with Ag, Cu, Y, Ru etc.

### EXAMPLE 1

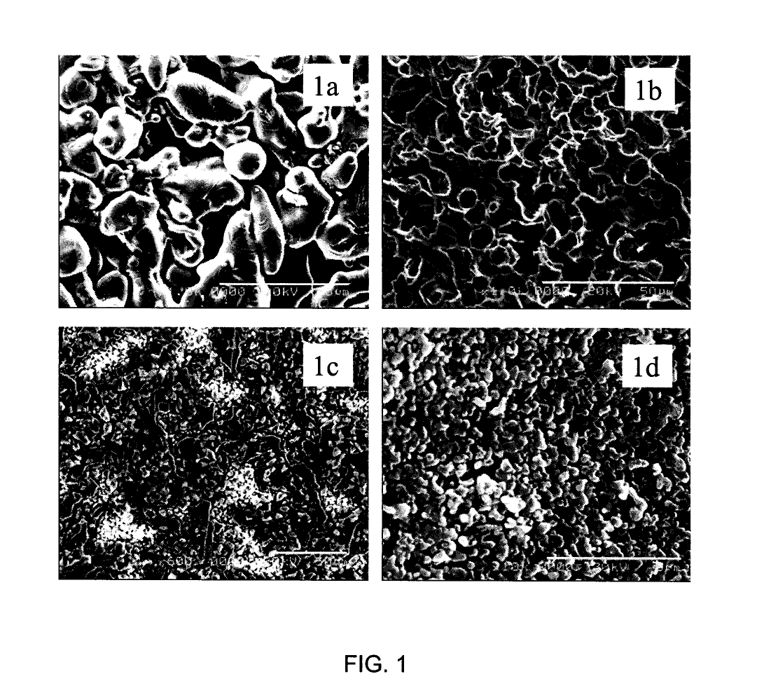

Porous stainless steel (SS316L) disc was obtained from Mott Corporation. The disc was 0.2 m grade and possessed a diameter of 25.4 mm, a thickness of 1.2 mm and a porosity of 20-40%. Its surface roughness was about 20 m, as shown in FIG. 1a. The surface of the disc to be deposited with hydrogen-selective layer was polished using sandpaper (Leco) with increasing grits step by step and was finally polished with 1200 grit sandpaper. The surface roughness of the disc was reduced to about 2 m. After polishing, most of the pore mouths on the surface of the disc were closed and gas permeability was reduced to less than 1% of that of the original disc.

The blocked pores must be opened up to recover the permeability of the disc. Acid etching was applied for this purpose. Only the polished surface was etched. Mixed acids of concentrated HCl (37% by wt.) and concentrated HNO₃ (69% by wt.) were used as etching solutions. The ratio of HCl to HNO₃ was in the range of 1 to 3, preferably 1.6. After 15-20 m thickness was etched away from the disc on the surface, all the pore mouths on the surface were opened up and the gas permeability of the disc was fully restored. FIG. 1b shows the surface of the etched surface. The surface had become smoother.

The etched disc was then coated with a ceramic layer to further modify its surface and to prevent the potential interdiffusion between the metallic membrane and the metal substrate. The sol-gel technique was employed to obtain the ceramic layers. The etched surface of the disc was first coated with the sol containing -alumina with a mean particle size of 2.5 m. In order to assure that alumina particles were predominantly coated in the entrances of the larger pores, a small vacuum (−0.1˜0.2 bar) was applied to the other side of the disc. As shown in FIG. 1c, only larger pores were filled with alumina particles, while smaller pores remained fully open, and hence the permeability of the coated substrate was not significantly diminished. Note also that very few particles were deposited on top of the solid pore peripheries so that the coated areas reached almost the same level as the pore peripheries. The disc was then coated a second time with the sol containing smaller -alumina particles of mean size 0.3 m. After each coating, the disc was calcined at 600° C. for 2 h in H₂/N₂ mixture. FIG. 1d shows the surface of the disc after the second coating. Unlike the first coating where the particles were predominantly deposited in the pore entrances, the smaller particles of the second coating spread out uniformly on the surface of the disc. It is seen from FIG. 1a-c that the surface roughness was reduced from about 20 m for the original disc to less than 1 m for the disc after coating with ceramic layers. Moreover, after ceramic coating, the entire surface of the disc was covered by the coated ceramic layers, thereby preventing interdiffusion between the stainless steel and Pd-based layer. The ceramic-coated disc remained very permeable with a hydrogen permeance as large as 390 Nm³/(m².h.bar).

The ceramic-coated disc was then pre-seeded with Pd nuclei and plated in a palladium bath by the commonly-used electroless plating technique. A thin (˜5 m) continuous Pd composite membrane was successfully deposited on the surface of the ceramic layer. The composite membrane was gas tight to N₂, indicating that the Pd membrane was pinhole-free. At 823 K and hydrogen pressure difference of 3.4, the composite membrane showed a very high hydrogen permeation fluxes, up to 95 m³/(m².h), and was stable during the testing period. These facts demonstrated the effectiveness of the ceramic layers in preventing interdiffusion and modifying the substrate surface so that it is possible to deposit a thin pinhole-free Pd membrane on the rough stainless steel substrate after proper treatment.

### EXAMPLE 2

A similar disc, manufactured in the same batch as the disc in example 1, was used as the substrate in this example. This disc was not subjected to the pretreatment steps, such as the polishing, etching and coating with ceramic layers. After cleaning, the disc was directly pre-seeded and then plated in a palladium bath using the same methods as in example 1. When the thickness of Pd layer on the disc reached 21 m, the Pd composite membrane was still not gas-tight to N₂, indicating the discontinuity of the Pd layer or the presence of pinholes. After further plating, the thickness of the Pd layer was about 35 m and the composite membrane became gas-tight. Compared to example 1, a much larger thickness was required to achieve a pinhole-free Pd layer on the untreated substrate. This composite membrane showed a significant decrease in hydrogen permeability when it was tested in hydrogen at 550° C., suggesting the occurrence of interdiffusion as result of the absence of the intermediate barrier layer.

### EXAMPLE 3

Another disc similar to the one in example 1 was used as the substrate in this embodiment. After this disc underwent the same pretreatment process and Pd plating process as in Example 1, a thin silver layer was deposited onto the surface of the Pd layer in a silver bath by electroless plating, followed by an annealing treatment in hydrogen at 450° C. After annealing, the Pd and Ag layers eventually formed a homogeneous alloy layer of thickness 6 m containing 24% (by wt.) Ag and 76% (by wt.) Pd. This alloy composite membrane was gas-tight to nitrogen.

### EXAMPLE 4

A similar Pd composite membrane was manufactured using the same procedure as in example 1, but the substrate was a porous stainless steel (SS316L, Mott Corp.) tube. The tube was also of 0.2 m grade with an O.D. of 12.7 mm, a thickness of 1.2 mm, a length of 101.6 mm and a porosity of 20-40%. A thin (5 m) and pinhole-free Pd composite membrane with an intermediate ceramic layer was successfully obtained and showed good stability at 550° C.

### EXAMPLE 5

When a composite membrane supported on porous metallic substrate needs to be scaled up and welded onto other stainless steel parts to form a module for practical applications, two problems are likely to be encountered. One is that gas could leak through the edge of the porous ceramic layer along the horizontal direction of the disc; the other is that the high temperature accompanying welding could destroy the Pd film on the edge, causing the membrane to leak.

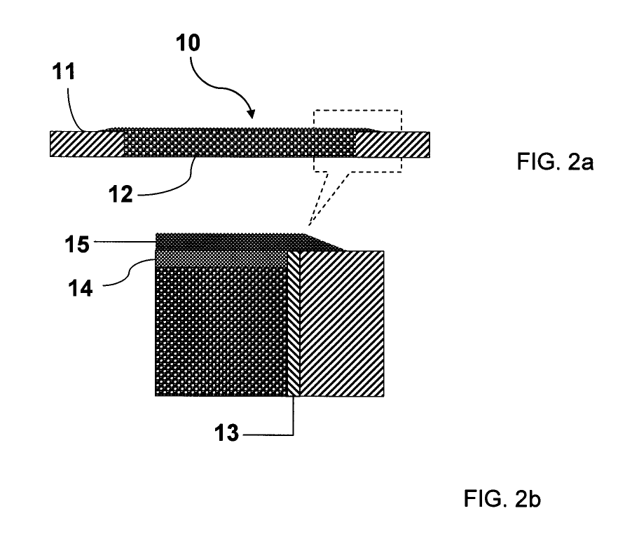

A novel configuration, shown schematically in FIGS. 2a and 2b, was applied to address these issues. FIG. 2 is a cross-sectional view of Pd composite membrane 10. The porous Hastelloy substrate disc (Mott Corp.) 12 was 0.2 m grade with a diameter of 25.4 mm, a thickness of 1.2 mm and a porosity of 20-40%. A solid Hastelloy wafer frame 11, which had the same thickness as the substrate 12 and an outside diameter of 50.8 mm with a hole of 25.4 mm in diameter in the center, was welded to the substrate 11. The welding 13 (see FIG. 2b) was almost of the same height as the substrate and wafer frame 12 and the substrate 11. The welded disc then underwent similar polishing, etching and coating processes as described in example 1. The ceramic layer 14 was only coated on the porous substrate 12. Pd layer 15 was then deposited on a larger area than substrate 12, fully covering the ceramic-coated area. Since the edge of the porous ceramic layer was completely covered by Pd film, leakage through it was prevented. In addition, the Pd film was far from the edge of the solid stainless steel wafer where the welding was carried out, enabling destruction of the Pd film due to the welding to be avoided. The thickness of the Pd film was 6 m and the composite membrane was gas-tight to nitrogen after plating.

### EXAMPLE 6

A similar configuration as in example 4 was adopted to manufacture a Pd composite membrane with a large area, where the porous Hastelloy substrate rectangle with a dimension of 76.2 mm by 58.4 mm was welded with a solid Hastelloy frame with a width of 12.7 mm. A thin (8 m) and pinhole-free Pd composite membrane with intermediate ceramic layer was obtained.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A composite membrane comprising a porous metal substrate, an intermediate layer and a hydrogen-selective metal layer.

2. The composite membrane of claim 1 wherein the porous metal substrate is planar or tubular in shape.

3. The composite membrane of claim 1 wherein the porous metal substrate is stainless steel, Hastelloy, or an alloy containing iron, nickel or chromium.

4. The composite membrane of claim 1 wherein the intermediate layer is porous ceramic, an oxide or a non-metallic refractory material.

5. The composite membrane of claim 1 wherein the intermediate layer is alumina, silica or titania.

6. The composite membrane of claim 1 wherein the intermediate layer overlies one surface of the substrate.

7. The composite membrane of claim 1 wherein the hydrogen-selective metal overlies the intermediate layer, opposite to the substrate.

8. The composite membrane of claim 1 wherein the hydrogen-selective metal is palladium, platinum, gold or an alloy of these metals with silver, yttrium, ruthenium or copper.

9. A method of manufacturing the composite membrane of claim 1, comprising pretreating the metal substrate, coating the substrate to obtain the intermediate layer and employing a deposition process to obtain the hydrogen-selective metal layer.

10. The method of claim 9 wherein the pretreatment process of the substrate includes a polishing step and an etching step.

11. The method of claim 10 wherein the polishing step includes the use of sandpapers.

12. The method of claim 10, wherein the etching step includes an etching solution which is a mixed acid consisting of nitric acid and hydrochloric acid.

13. The method of claim 9, wherein the pretreatment process, compared with the original substrate, the roughness of the polished surface of the pretreated substrate is significantly smaller while the strength and gas permeability of the pretreated substrate is subject to little change.

14. The method of claim 9 wherein the coating is conducted by sol-gel technology.

15. The method of claim 9, wherein the intermediate layer is obtained by first coating the pretreated substrate with a sol containing larger particles and then by a second coating with a sol containing smaller particles; the larger particles from the first coating being predominantly coated into porous entrances and pits of the substrate, while the smaller particles from the second coating are coated onto the entire surface of the substrate where the hydrogen-selective metal is to be deposited, followed by drying or calcination after each coating.

16. The method of claim 15, wherein both sols comprise −AlOOH.

17. A deposition process for obtaining the hydrogen-selective metal layer of claim 9, wherein the techniques for depositing the hydrogen-selective metals is sputtering, CVD, MOCVD, electroplating or electroless plating; electroless plating is preferred.

18. A membrane module comprising a composite membrane according to claim 1 and a solid frame for planar substrate or solid end tubes for tubular substrate.

19. The membrane module of claim 18, wherein the solid frame is welded to the perimeter of the planar substrate or the solid tubes are welded to both ends of the tubular substrate before the pretreatment process of the substrate according to the method of claim 9; the material of the solid frame and the solid tube matching the substrate.

20. The membrane module of claim 18, wherein the membrane module is manufactured in the same manner by the method of claim 9; the polishing step being applied to the entire surface of the welded substrate, the etching and the ceramic coating steps are applied only to the surface of the porous substrate, and the hydrogen-selective metal layer covering a surface area that is a little larger than the that of the porous substrate.
